(19) United States
(12) Patent Application Publication
(10) Pub. No.: US 2020/0063571 A1
(43) Pub. Date: Feb. 27, 2020

(54) CERAMIC MATRIX COMPOSITE TURBINE BLADE WITH LIGHTENING HOLE

(71) Applicants: Rolls-Royce North American Technologies Inc., Indianapolis, IN (US); Rolls-Royce Corporation, Indianapolis, IN (US); Rolls-Royce High Temperature Composites Inc., Cypress, CA (US)

(72) Inventors: Ted J. Freeman, Danville, IN (US); Aaron D. Sippel, Zionsville, IN (US); Robert J. Shinavski, Mission Viejo, CA (US)

(21) Appl. No.: 16/113,502

(22) Filed: Aug. 27, 2018

(51) Int. Cl. F01D 5/14; F01D 5/28

(52) U.S. Cl. CPC F01D 5/147; F01D 5/284; F05D 2250/291; F05D 2240/307; F05D 2300/6033; F05D 2220/32

(57) ABSTRACT

A turbine blade of ceramic matrix composite material construction adapted for use in a gas turbine engine is disclosed. The turbine blade includes an airfoil and a tip to discourage air leakage over the tip of the turbine blade. The turbine blade is designed considering weight and strength to include a lightening hole.

### FIELD OF THE DISCLOSURE

The present disclosure relates generally to turbine blades for gas turbine engines, and more specifically to turbine blades constructed with ceramic matrix composites.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Turbine blades interact with the hot, high-pressure products of the combustor and convert them to mechanical rotation. The interaction of combustion products with the blades heats the blades. Turbine blades are often made from high-temperature compatible materials and/or are actively cooled by supplying relatively cool air to the turbine blades. To this end, some airfoils incorporate composite materials to withstand very high temperatures. Design and manufacture of turbine blades from composite materials presents challenges because of the geometry and strength required for the parts.

### SUMMARY

Turbine blades are used in gas turbine engines to extract work from the hot, high pressure gasses discharged out of a combustor. Turbine blades are designed to be rotated at high speeds in a high-temperature and high-pressure environment. Turbine blades can be manufactured from ceramic matrix composite materials to withstand the high temperatures. Reducing the overall weight of such a turbine blade can be advantageous, because reducing the weight of the turbine blade reduces the overall centrifugal load created when the turbine blade is rotated.

In some embodiments according to the present disclosure, a ceramic matrix composite turbine blade includes lightening holes to reduce the overall weight of the turbine blade. Lightening holes can be formed by creating a void in an airfoil of the turbine blade. These lightening holes can also extend through a tip formed at the end of the airfoil. The lightening holes may also be formed by creating a void in the root of the turbine blade. In some designs, the turbine blade may also include reinforcement ribs that extend across the lightening hole to support the turbine blade round the lightening holes.

Lightening holes can be formed in various shapes. Some examples include an airfoil shape, a circle, or a race track shape. The lightening holes can change shape as they extend either into the airfoil or into the root.

As noted above, turbine blades can include a tip at the end of its airfoil. Tips used in turbine blades can come in various designs that prevent air from leaking over the tip of the turbine blade. In one specific embodiment disclosed, the turbine blade includes a squealer tip with an indentation adapted to create a turbulent air path, which prevent air from leaking over the tip of the turbine blade. In such an embodiment, the lightening hole can be located in the exposed portion of the radially outermost surface of the airfoil. In other embodiments, lightening holes can be integrated with flat tips, winglet tips, or tip shrouds.

### BRIEF DESCRIPTION OF THE DRAWINGS

FIG. 1 is a perspective view of a turbine blade showing a first lightening hole is formed in an airfoil of the turbine blade and a second lightening hole is formed in a root of the turbine blade, the lightening holes being incorporated to reduce weight of the turbine blade;

FIG. 2 is a detail perspective view of the airfoil illustrated in FIG. 1 showing a squealer tip defined by a lip extending from the radially outermost surface of the airfoil forming an indentation, the first lightening hole begins at the radially outermost surface into the airfoil and extends into the airfoil;

FIG. 3 is a cross-sectional view of the root illustrated in FIG. 1 showing that the root is formed to include the second lightening hole extending into the root of the turbine blade;

FIG. 4 is a cross-sectional view of the airfoil illustrated in FIG. 2 taken at line 4-4 showing composite construction of the airfoil and the squealer tip from plies of reinforcement in a matrix material, in which the plies have differing heights to define the lightening hole, the indentation of the squealer tip, the lip of the squealer tip, and the airfoil;

FIG. 5 is a cross-sectional view of the airfoil illustrated in FIG. 2 taken at line 5-5 showing the contoured cutout in one of the plies, in which the ply has different heights along the length of the ply so as to define the lightening hole, the indentation of the squealer tip, the lip of the squealer tip, and the airfoil;

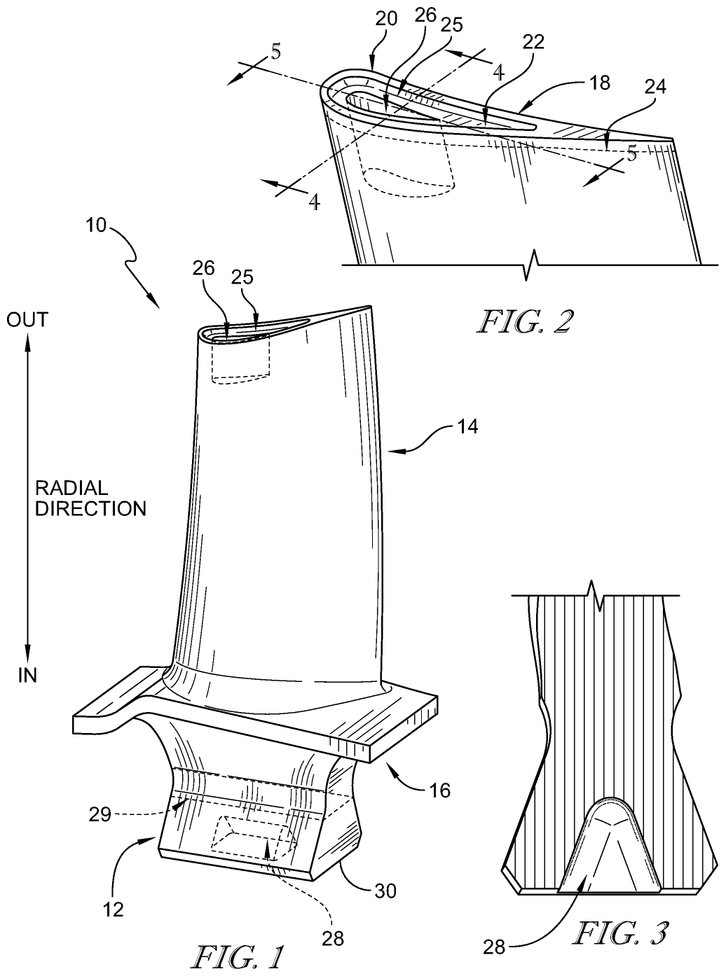

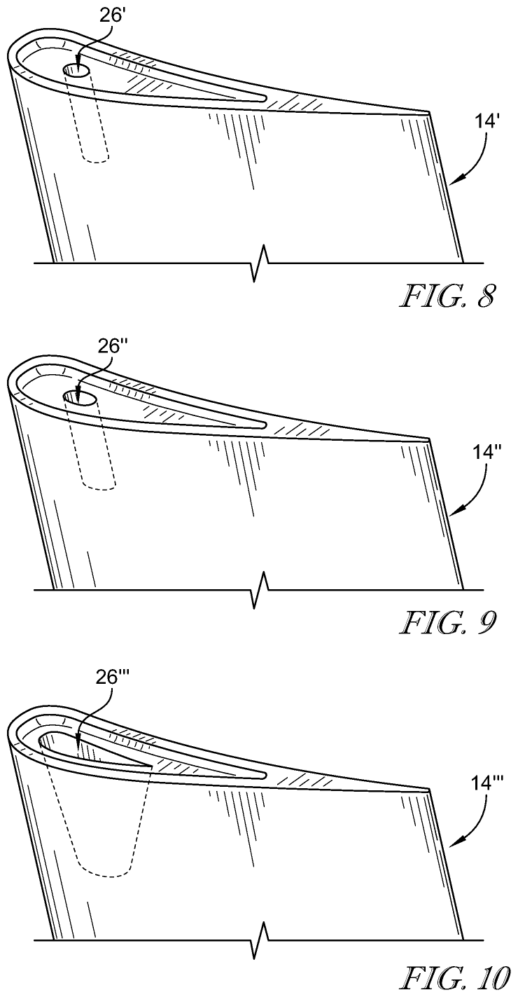

FIG. 4A is a cross-sectional view of an alternative construction of the airfoil adapted for use in the turbine blade of FIG. 1 showing the first lightening hole with an additional ply lining the lightening hole;

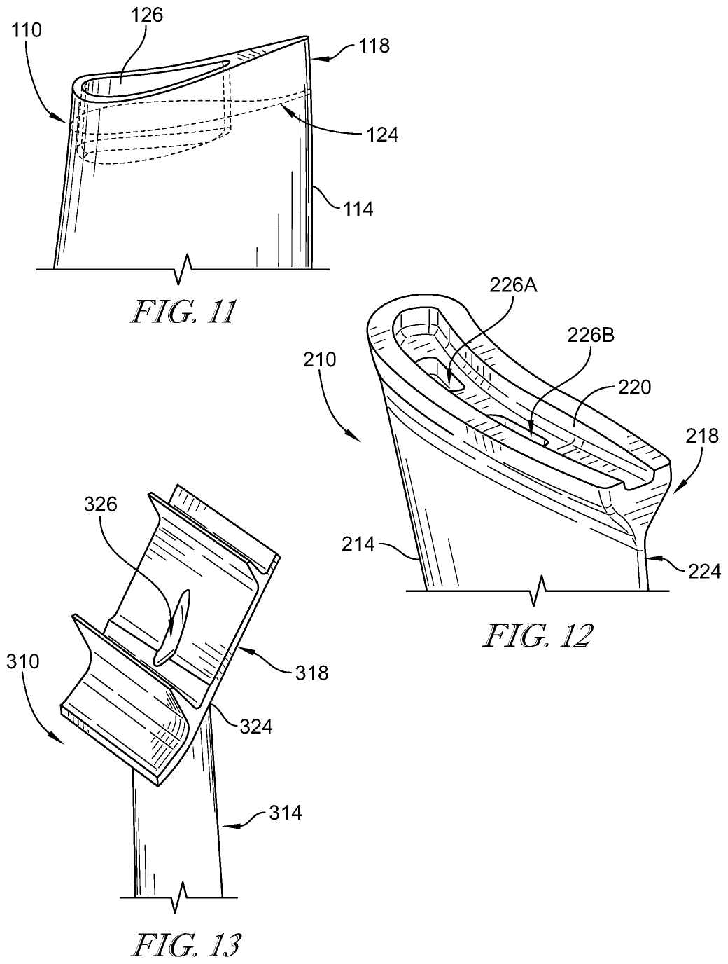

FIG. 5A a cross-sectional view of the alternative construction of the turbine blade in FIG. 4A showing the first lightening hole with the additional ply lining the first lightening hole;

FIG. 6 is a perspective view of a second airfoil adapted for use in the turbine blade of FIG. 1 showing a rib spanning a first lightening hole to reinforce the airfoil;

FIG. 7 is a cross-sectional view of the second airfoil of FIG. 6 taken at line 7-7 showing the rib extending the radial height of the first lightening hole;

FIG. 8 is a detail perspective view of a third airfoil showing a lightening hole having a round cross-sectional shape;

FIG. 9 is a detail perspective view of a fourth airfoil showing a lightening hole having a cross-sectional racetrack shape with semi-circular ends and connected by flat sides;

FIG. 10 is a detail perspective view of a fifth airfoil showing a lightening hole tapering as it extends into the airfoil;

FIG. 11 is a detail perspective view of a sixth airfoil with a flat tip and a lightening hole formed from the radially outermost surface of the airfoil and extending into the airfoil;

FIG. 12 is a detail perspective view of a seventh airfoil with a winglet on the radially outermost end of the airfoil and multiple lightening holes formed from the radially outermost surface of the airfoil and extending into the airfoil; and

FIG. 13 is a detail perspective view of an eighth airfoil showing an airfoil with a tip shroud on the end of an airfoil and a lightening hole formed through the tip shroud and extending into the airfoil.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

A turbine blade 10 made of ceramic matrix composite materials formed with lightening holes 26, 28 that reduce overall weight of the turbine blade 10 is shown in FIG. 1. Reducing the overall weight of the turbine blade 10 reduces the centrifugal load that is created by the turbine blade 10 when it is rotated about an axis. The ceramic turbine blade 10 is adapted for use in a gas turbine engine operating at high temperatures.

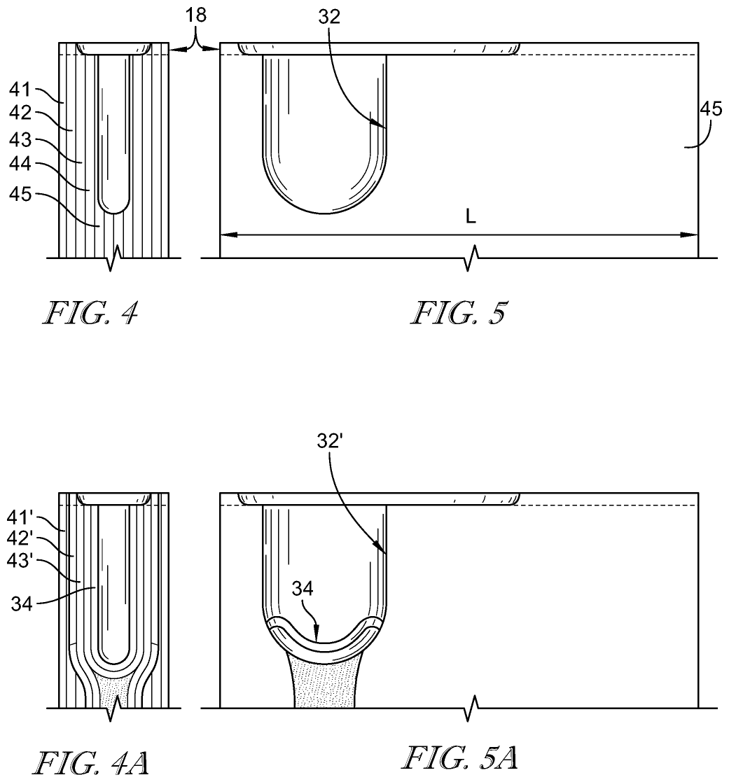

The lightening holes 26, 28 can have differing shapes such as an airfoil shape, a circular shape, a racetrack shape, as shown in FIGS. 2 and 8-9. Moreover, lightening holes 26, 28 can taper as it extends radially inward as shown in FIG. 10. The turbine blade 10 can also have multiple lightening holes 26, 28. The lightening holes 26, 28 can be formed in an airfoil 14 and/or root 12 of the turbine blade 10 as shown in FIG. 2. Various turbine blades 10, 120, 210, 310 can incorporate lightening holes 26, 126, 226, 326 with a variety of tips 18, 118, 218, 318 for discouraging air leakage over the top of the turbine blade 10, 110, 210, 310 as shown in FIGS. 2 and 11-13. Optional reinforcement ribs 36 arranged in the lightening hole 26 can provide support to the associated airfoil 14.

The illustrative turbine blade 10 adapted for use in a gas turbine engine is constructed of ceramic matrix composite material (CMC) as shown in FIG. 1. An embodiment of the turbine blade includes a root 12, an airfoil 14, and a platform 16. The root 12 is adapted to attach the turbine blade 10 to a disk within the gas turbine engine. The airfoil 14 extends outward from the root 12 in the radial direction as indicated in the drawing. The airfoil 14 is shaped to cause the rotation of the turbine blade 10 about a central axis when the airfoil 14 interacts with hot gasses moving through the associated gas turbine engine. The turbine blade 10 can include a platform 16 to prevent migration of gasses from the flow path to the root 12.

A squealer tip 18 is attached to the radially outermost surface of the airfoil 24 as shown in FIG. 2, and creates a turbulent air path to discourage air leakage over the tip of the turbine blade 10. The squealer tip 18 is formed to include a lip 20 that extends radially outward from the radially outermost surface of the airfoil 24 in the shape of the airfoil. The lip 20 surrounds an exposed portion of the radially outermost surface of the airfoil 22 such that an indentation 25 is defined by the lip 20 and the exposed portion of the radially outermost surface 24. The indentation 25 is sized to create a turbulent air path across the squealer tip 18 to discourage air leakage over the tip of the turbine blade.

A first lightening hole 26 is formed in the airfoil 14 within the area of the exposed portion of the radially outermost surface of the airfoil 22 as shown in FIG. 2. The first lightening hole 26 extends into the airfoil 14 to reduce the weight of the turbine blade 10, and in turn, the centrifugal load applied by the turbine blade 10 to a corresponding disk when the turbine blade 10 is used in a gas turbine engine. The first lightening hole 26 has the cross-sectional shape of an airfoil.

The first lightening hole 26 shown in FIG. 2 illustratively has a longer radial height than the lip 20 of the squealer tip 18. The first lightening hole 26 does not taper as it extends into the airfoil 14. The first lightening hole 26 extends into the top third of the airfoil 14 and is a blind hole. The shape and depth of the first lightening hole 26 is determined by the amount of weight that is desired to be eliminated coupled with the location where section stress increases to the point where a reduction in material increases the stress to an unacceptable level.

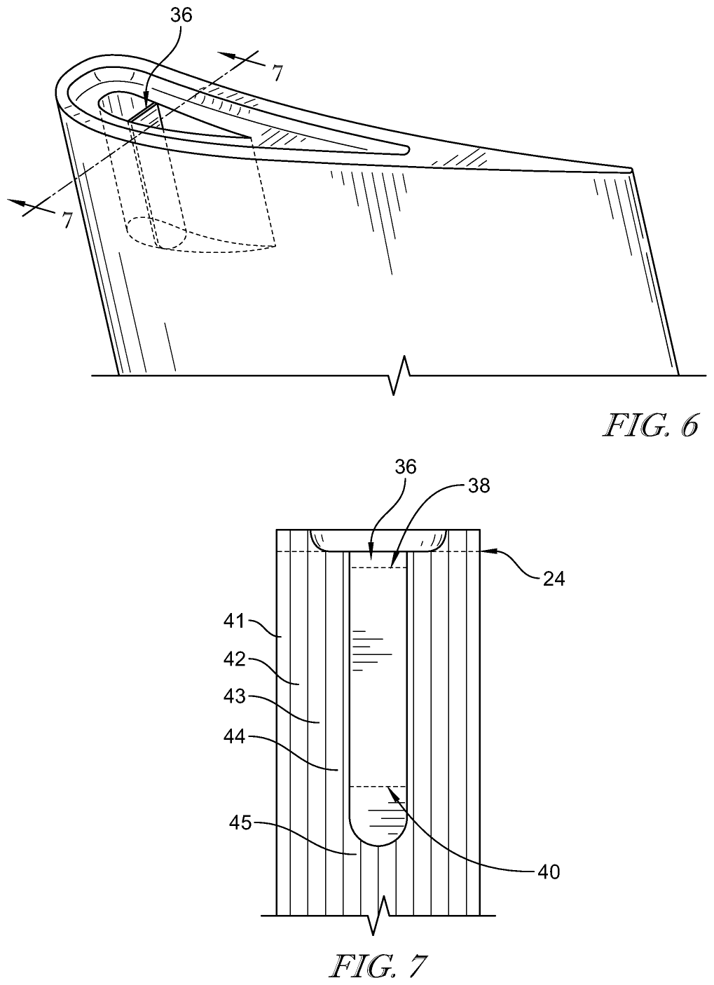

As shown in FIG. 3, a second lightening hole 28 is formed in the root 12. The second lightening hole 28 also reduces the weight of the turbine blade 10, and in turn, the centrifugal load applied by the turbine blade 10 to a corresponding disk. The second lightening hole 28 extends from the radially innermost surface of the root 30, and extends into the root. The second lightening hole 28 does not extend into the root 12 past the plane of maximum stress 29. The second lightening hole 28 tapers as it extends into the root 12.

In the illustrative embodiment, the shape of the squealer tip 18 and airfoil 14, including the first lightening hole 26, are formed by the shape and arrangement of the ceramic matric composite materials. The plies of reinforcement 41, 42, 43, 44, 45 are suspended in matrix material to form the overall composite component which is shown in FIGS. 4-5 and 4A-5A. The top narrow edge of each ply 41, 42, 43, 44, 45 can differ in height in the radial direction along the length L of the ply to form the lip 20 of the squealer tip 18, the exposed outermost surface of the airfoil 22, and the shape of the airfoil 14 around the first lightening hole 26. The top narrow edge of certain plies can form the surface of the airfoil exposed to the first lightening hole 32 as shown in FIG. 4.

Alternatively, the narrow edges could be covered by an additional bathtub-shaped ply 34 as shown in FIG. 4A. The additional ply 34 is positioned so that the primary broad surface of the ply 34 faces the surface of the airfoil exposed to the first lightening hole 32′. The additional ply 34 can cover all of the top narrow edges of the plies 41, 42, 43, 44, or the additional ply 34 could cover only some of the narrow edges as shown in FIG. 5A.

As shown in FIGS. 6 and 7, the airfoil 14 can include a reinforcement rib 36 that extends across the lightening hole 26 where the reinforcement rib 36 is attached to the surface of the airfoil exposed to the lightening hole 32 to provide structural support to the turbine blade 10. The reinforcement rib 36 can be different heights. For example the reinforcement rib 36 can extend from radially innermost end of the first lightening hole and end at the radially outermost surface of the airfoil 24 as shown in FIG. 6. The reinforcement rib 36 can also extend from the radially innermost end of the first lightening hole and extend only partway up the airfoil 14 so the radial height of the reinforcement rib 36 is less than the radial height of the first lightening hole 26, as shown in phantom 38 in FIG. 7. The reinforcement rib 36 can also extend from a radial height shown in phantom 40 and extend to the radially outermost surface of the airfoil 24. The reinforcement rib 36 can extend any portion of the radial height of the first lightening hole.

The lightening hole can be formed in a variety of shapes as shown in FIGS. 2 and 8-10. The lightening hole may have a different cross-section shape when viewed from the tip looking radially into the airfoil. For example the lightening hole 26′ can have a circular shape extending into an airfoil 14′ as shown in FIG. 8. In another example, the lightening hole 26″ can have a racetrack shape formed by semi-circular ends connected by flat sides extending into the airfoil 14″ as shown in FIG. 9. The lightening hole 26′″ may have a different cross-sectional shape as the lightening hole 26′″ extends into the airfoil 14′″. The lightening hole 26′″ tapers as it extends into the airfoil 14′″ as shown in FIG. 10.

In another embodiment shown in FIG. 11, a portion of a turbine blade 110 adapted for use in a gas turbine engine is constructed with a lightening hole 126 to reduce the weight of the turbine blade. The portion of the turbine blade is similar to the turbine blade 10 in that the turbine blade 110 includes an airfoil 114 and a lightening hole 126 similar to the airfoil 14 and lightening hole 26 of turbine blade 10.

In the embodiment shown in FIG. 11, a flat tip 118 extends from the radially outermost surface of the airfoil 124. The lightening hole 126 extends through the flat tip 118 and into the airfoil 124 to reduce the weight of the turbine blade 110, and in turn, the centrifugal load applied by the turbine blade 110 to a corresponding disk when the turbine blade 110 is used in a gas turbine engine.

In another embodiment shown in FIG. 12, a portion of a turbine blade 210 adapted for use in a gas turbine engine is constructed with two lightening holes 226A, 226B to reduce the weight of the blade. The portion of the turbine blade is similar to the turbine blade 10 in that the turbine blade 210 includes an airfoil 214 and lightening holes 226A, 226 B similar to the airfoil 14 and lightening hole 26 of turbine blade 10.

In the embodiment shown in FIG. 12, the portion of a turbine blade includes a winglet 218 to discourage air leakage over the top of the turbine blade. The winglet 218 extends from the radially outermost surface of the airfoil 224. The winglet 218 is formed from a lip 220 that extends from the radially outermost surface of the airfoil 224 and flares, so the lip 220 of the winglet 218 is wider than the radially outermost surface of the airfoil 224.

In another embodiment shown in FIG. 13, a portion of a turbine blade 310 adapted for use in a gas turbine engine is constructed with a lightening hole 326 to reduce the weight of the blade. The portion of the turbine blade is similar to the turbine blade 10 in that the turbine blade 310 includes an airfoil 314 and a lightening hole 326 similar to the airfoil 14 and lightening hole 26 of turbine blade 10.

The embodiment shown in FIG. 13 includes a tip shroud 318 to discourage air from leaking over the tip of the turbine blade. The tip shroud 318 extends from the radially outermost surface of the airfoil 324. The tip shroud 318 is a formed by a plate with at least one ridge. The lightening hole 326 extends through the tip shroud 318 and into the airfoil 314.

In an attempt to improve turbine efficiency, combustor outlet temperatures continue to rise to improve cycle efficiency and power density. Incorporation of ceramics matrix components into the turbine section offer the potential of reducing cooling air requirements due to their higher temperature capability and reducing engine weight due to their low density. The present disclosure describes a lightening hole (e.g., lightening holes 26, 26′, 26″, 26′″, 126, 226A, 226B, 326) that can be included within a turbine blade (eg., the turbine blade 10) to further reduce the weight of the turbine blade. The lightening hole is a recess in the tip (eg., tips 18, 118, 218, 318) and/or airfoil (eg., airfoil 14, 114, 214, 314) of the turbine blade where material has been removed to reduce the weight of the turbine blade.

The lightening hole could be airfoil shaped (eg., lightening hole 26), a round hole (eg., lightening hole 26′) or any other shape hole conducive to insertion in the tip of the blade (eg., lightening hole 26″ and 26′″). The depth of the lightening hole is determined by the amount of weight that is desired to be eliminated coupled with the location where section stress increases to the point where a reduction in material increases the stress to an unacceptable level.

Depending upon the method of manufacture, it can be envisioned that the shape of the lightening hole could change with respect to the depth of the hole (eg., 26′″). It is further envisioned that that the lightening hole could taper in size becoming smaller the further you move radially inward—this could allow for the feature to be manufactured deeper than a simple section extrusion. Additionally it is possible that a reinforcement rib 36 might be needed if the lightening hole were of a substantial size and depth that the stiffness of the resulting flowpath layer(s) was insufficient to handle dynamic effects.

It is envisioned that lightening holes could be manufactured by including them in the base material fabrication process and by machining them afterwards, or a combination of the two. It is further envisioned that it might be possible to put a ceramic matrix composite cap on top of the lightening hole.

The ceramic matric composite materials could be formed as a planar concentration of fibers formed in a two dimensional lay-up. The ceramic matric composite materials can also be formed as a multi-directional preform in a three-dimensional or angle interlock fiber architecture.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine blade made for rotation about an axis upon use in a gas turbine engine, the turbine blade comprising
an airfoil comprising ceramic matrix composite materials adapted for use in high temperature environments,
a squealer tip extending from a radially outermost surface of the airfoil, the squealer tip formed to include a lip that extends radially outward from the radially outermost surface of the airfoil in the shape of the airfoil, the lip surrounding an exposed portion of the radially outermost surface of the airfoil such that an indentation is defined by the lip and the exposed portion of the radially outermost surface of the airfoil such that the indentation is sized to create a turbulent air path across the squealer tip to discourage air leakage over the tip of the turbine blade, and
a first lightening hole extending from the radially outermost surface of the airfoil and extending into the airfoil to reduce the weight of the airfoil and accordingly centrifugal load created by the turbine blade when rotated about the axis during use in a gas turbine engine.

2. The turbine blade of claim 1, wherein the first lightening hole is a blind hole.

3. The turbine blade of claim 2, wherein the cross-section of the lightening hole is contained within the exposed portion of the radially outermost surface of the airfoil.

4. The turbine blade of claim 3, wherein the cross-section of the lightening hole has an airfoil shape.

5. The turbine blade of claim 3, wherein the cross-section of the lightening hole has a circular shape.

6. The turbine blade of claim 3, wherein the cross-section of the lightening hole has a racetrack shape with semi-circular ends connected by flat sides.

7. The turbine blade of claim 1, further comprising a reinforcement rib located in the lightening hole and supporting the surface of the airfoil exposed to the lightening hole.

8. The turbine blade of claim 7, wherein the reinforcement rib begins from the radially innermost end of the lightening hole and extends to the radially outermost surface of the airfoil.

9. The turbine blade of claim 7, wherein the reinforcement rib begins from the radially innermost end of the lightening hole and extends radially outward only partway through the first lightening hole so the radial height of the reinforcement rib is less than the radial height of the lightening hole.

10. A turbine blade made for rotation about an axis upon use in a gas turbine engine, the turbine blade comprising
an airfoil comprising ceramic matrix composite materials adapted for use in high temperature environments,
a tip that begins on a radially outermost surface of the airfoil and extends radially out,
a first lightening hole extending from the radially outermost surface of the airfoil and extending into the airfoil to reduce the weight of the airfoil and accordingly, centrifugal load created by the turbine blade when rotated about the axis during use in a gas turbine engine.

11. The turbine blade of claim 10, wherein the tip is a flat tip that extends radially outward from the radially outermost surface of the airfoil.

12. The turbine blade of claim 10, wherein the tip is a winglet formed to include a lip that extends radially outward from the radially outermost surface of the airfoil and flares beyond the cross-section of the airfoil, the lip surrounding an exposed portion of the radially outermost surface of the airfoil such that an indentation is defined by the lip and the exposed portion of the indentation sized to create a turbulent air path across the winglet discouraging air from leaking over the tip of the turbine blade.

13. The turbine blade of claim 10, wherein the tip is a tip shroud formed to include a plate, and at least one ridge.

14. The turbine blade of claim 10, further comprising a reinforcement rib located in the lightening hole and supporting the surface of the airfoil exposed to the lightening hole.

15. The turbine blade of claim 14, wherein the reinforcement rib begins from the radially innermost end of the lightening hole and extends to the radially outermost surface of the airfoil.

16. The turbine blade of claim 14, wherein the reinforcement rib begins from the radially innermost end of the lightening hole and extends radially outward only partway through the first lightening hole so the radial height of the reinforcement rib is less than the radial height of the lightening hole.

17. The turbine blade of claim 10, wherein the shape of the turbine blade is formed by plies of fiber reinforcement and the plies have differing radial heights to define the lightening hole, the tip, and the airfoil.

18. The turbine blade of claim 17, wherein the plies of reinforcement have narrow edges that form the surface of the airfoil exposed to the lightening hole.

19. The turbine blade of claim 17, wherein the primary broad surface of at least ply of reinforcement forms the surface of the airfoil that faces the lightening hole.

20. A turbine blade made for rotation about an axis upon use in a gas turbine engine, the turbine blade comprising
an airfoil comprising ceramic matrix composite materials adapted for use in high temperature environments,
a root adapted to attach the turbine blade to a disk within the gas turbine engine,
a second lightening hole extending from the radially innermost surface of the root and extending into the root.
